(19) United States
(12) Patent Application Publication
(10) Pub. No.: US 2017/0366429 A1
(43) Pub. Date: Dec. 21, 2017

(54) COMMUNICATION APPARATUS, COMMUNICATION SYSTEM, AND COMMUNICATION METHOD

(71) Applicant: NEC Corporation, Tokyo (JP)

(72) Inventor: Noriaki KISHITA, Tokyo (JP)

(73) Assignee: NEC Corporation, Tokyo (JP)

(21) Appl. No.: 15/543,126

(22) PCT Filed: Nov. 12, 2015
(86) PCT No.: PCT/JP2015/005639

§ 371 Date: Jul. 12, 2017

(30) Foreign Application Priority Data
Jan. 14, 2015 (JP) 2015-004661

(51) Int. Cl. H04L 12/26; H04L 12/24; H04L 12/707

(52) U.S. Cl. CPC H04L 43/0817; H04L 45/22; H04L 41/0686; H04L 43/065; H04L 43/18

(57) ABSTRACT

To detect a failure in a link or a failure in a network due to a frame loss between apparatuses, and degenerate a band in communication in which a frame is divided and divided frames are transmitted. A communication apparatus (100) includes a transmitter-receiver (101) configured to receive divided frames transmitted through a plurality of paths, the divided frame being obtained by dividing a frame, and a coupler (103) configured to couple the received divided frames, in which when the coupling of the received divided frames has failed in the coupler, the transmitter-receiver (101) transmits a signal-faulty signal indicating a transmission fault. When the communication apparatus (100) has failed in coupling frames, it can detect a failure in a link or a failure in a network due to a frame loss between apparatuses by transmitting a signal-faulty signal indicating a transmission fault.

### TECHNICAL FIELD

The present disclosure relates to a communication apparatus, a communication system, and a communication method. In particular, the present disclosure relates to a communication apparatus, a communication system, and a communication method for performing communication by using a link aggregation function.

### BACKGROUND ART

In recent years, as a technique for expanding a communication band, there is a link aggregation in which a plurality of physical links are bundled and used as one logical link.

In the link aggregation, since the band width of the logical link is equal to the total of the band widths of individual links, the band width can be expanded. Further, in the link aggregation, even if a failure occurs in one of the links, communication is continued by using the remaining links, i.e., a degeneracy process is performed. Therefore, redundancy is ensured.

For example, Patent Literatures 1 to 3 disclose a technique for improving redundancy in a link aggregation or a technique for coping with a failure.

### CITATION LIST

### Patent Literature

Patent Literature 1: Japanese Unexamined Patent Application Publication No. 2008-160227

Patent Literature 2: Japanese Unexamined Patent Application Publication No. 2005-347943

Patent Literature 3: Japanese Unexamined Patent Application

Publication No. 2006-245849

### SUMMARY OF INVENTION

### Technical Problem

However, a related-art communication apparatus detects a failure between apparatuses on both sides of a port for which a link aggregation is implemented. Therefore, there is a problem that when a link aggregation is implemented by dividing a frame and transmitting divided frame in communication that is performed through a plurality of links, it is impossible to detect a failure that occurs in one of links that are adjacent to neither the communication source nor the communication entity on the other side.

### Solution to Problem

A communication apparatus according to the present disclosure includes: a transmitter-receiver configured to receive divided frames transmitted through a plurality of paths, the divided frame being obtained by dividing a frame; and a coupler configured to couple the divided frames, in which when the coupling of the divided frames has failed in the coupler, the transmitter-receiver transmits a signal-faulty signal indicating a transmission fault.

A communication system according to the present disclosure is a communication system configured to perform communication through a plurality of paths, the communication system including: a first communication apparatus configured to divide a frame and transmit divided frames through the plurality of paths; and a second communication apparatus configured to receive the divided frames through the plurality of paths and couple the received frames, in which when the coupling of the frames has failed, the second communication apparatus transmits a signal-faulty signal indicating a transmission fault to the first communication apparatus.

A communication method according to the present disclosure is a communication method in which first and second communication apparatuses perform communication through a plurality of paths, the communication method including: a divided frame transmission step of, in the first communication apparatus, dividing a frame and transmitting divided frames through respective paths; a coupling step of, in the second communication apparatus, coupling frames received through the plurality of paths; and an SF signal transmission step of, in the second communication apparatus, transmitting a signal-faulty signal indicating a transmission fault to the first communication apparatus when the coupling of the frames has failed.

### Advantageous Effects of Invention

A communication apparatus according to the present disclosure can detect a failure in a link or a failure in a network due to a frame loss between apparatuses, and degenerate a band in communication in which a frame is divided and divided frames are transmitted.

### BRIEF DESCRIPTION OF DRAWINGS

FIG. 1 is a block diagram showing a configuration of a communication apparatus according to an embodiment;

FIG. 2 is a flowchart sowing an operation of the communication apparatus according to the embodiment;

FIG. 3 is a flowchart sowing an operation of the communication apparatus according to the embodiment;

FIG. 4 is a block diagram sowing a configuration of the communication apparatus according to the embodiment;

FIG. 5 is a flowchart sowing an operation of the communication apparatus according to the embodiment;

FIG. 6 shows an outline of a communication system using communication apparatuses according to the embodiment;

FIG. 7 shows an outline of a communication system using the communication apparatus according to the embodiment;

FIG. 8 is a schematic diagram showing an example of transmission and reception of a signal in the communication system according to the embodiment;

FIG. 9 is a schematic diagram showing an example of transmission and reception of a signal in the communication system according to the embodiment;

FIG. 10 is a schematic diagram showing an example of transmission and reception of a signal in the communication system according to the embodiment;

FIG. 11 is a schematic diagram showing an example of transmission and reception of a signal in the communication system according to the embodiment;

FIG. 12 is a schematic diagram showing an example of transmission and reception of a signal in the communication system according to the embodiment;

FIG. 13 is a schematic diagram showing an example of transmission and reception of a signal in the communication system according to the embodiment; and

FIG. 14 is a block diagram showing a configuration of a communication apparatus according to the embodiment.

### DESCRIPTION OF EMBODIMENTS

### Embodiments

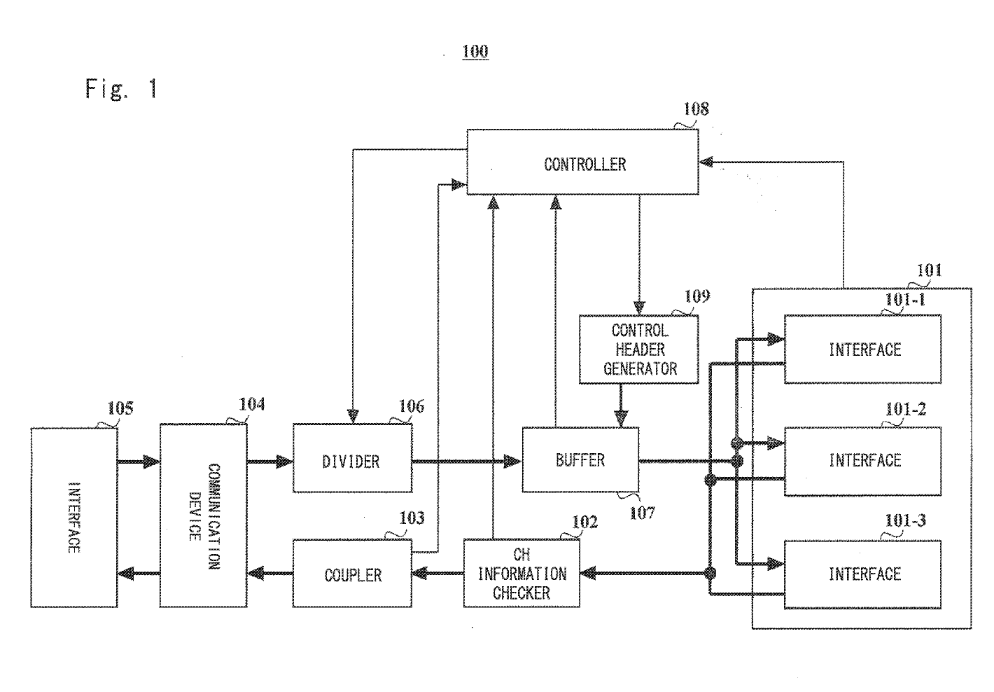

Embodiments according to the present disclosure are explained hereinafter with reference to the drawings. FIG. 1 is a block diagram showing a configuration of a communication apparatus according to this embodiment. In FIG. 1, a communication apparatus 100 includes an interface 101, a CH information checker 102, a coupler 103, a communication device 104, an interface 105, a divider 106, a buffer 107, a controller 108, and a control header generator 109.

Further, the interface 101 includes interfaces 101-1 to 101-3 which perform communication on a port-by-port basis. The following explanation is given on the assumption that: the interface 101-1 corresponds to a port A; the interface 101-2 corresponds to a port B; and the interface 101-3 corresponds to a port C. The above-described configuration is preferably implemented by hardware such as a logic circuit.

The interfaces 101-1 to 101-3 receive divided frames transmitted from a counterpart communication apparatus and output them to the CH information checker 102. These divided frames are obtained by dividing a frame. Further, the interfaces 101-1 to 101-3 transmit divided frames to the counterpart communication apparatus.

For example, the interfaces 101-1 to 101-3 are interfaces in a layer 1. Specifically, for the interfaces 101-1 to 101-3, a wired communication apparatus such as an Ethernet (Registered Trademark) or a wireless communication apparatus using FDD (Frequency Division Duplex) or the like is preferred.

The CH information checker 102 checks a content of CH information (Control Header Information) of the received divided frame and detects whether or not control information is included in the CH information of the received divided frame. Then, the CH information checker 102 outputs information on a port corresponding to the received divided frame and the control information to the controller 108. Specifically, the control information preferably includes information as to whether frames to be transmitted should be coupled or should not be coupled.

Further, the CH information checker 102 extracts a sequence number included in the CH information of the received divided frame and outputs the extracted sequence number together with the divided frame to the coupler 103. This sequence number indicates an order according to which the divided frames are coupled.

The coupler 103 couples the divided frames according to the order of the sequence number and outputs the coupled frame to the communication device 104. Further, when the coupler 103 has failed in coupling the divided frames, it outputs information that the coupling has failed to the controller 108. For example, when some number is skipped in the order of the sequence number, the coupler 103 outputs information that the coupling of frames has failed and the skipped sequence number (or information on a corresponding port) to the controller 108.

The communication device 104 performs a predetermined communication process for the coupled frame and outputs the processed frame to the interface 105. Further, the communication device 104 performs a predetermined communication process for a frame output from the interface 105 and outputs the processed frame to the divider 106. For example, it is preferably a communication process in a data link layer (Layer 2) or a higher layer, i.e., a layer higher than the physical layer.

The interface 105 transmits the processed frame to another communication entity with which the communication apparatus 100 communicates through a wire or wirelessly. Further, the interface 105 performs a process for a frame that is transmitted from another communication entity with which the communication apparatus 100 communicates through a wire or wirelessly, and outputs the processed frame to the communication device 104.

The divider 106 divides a frame according to an instruction from the controller 108 and outputs the divided frames to the buffer 107. For example, when the divider 106 is instructed to divide a frame for three ports, i.e., the ports A to C, the divider 106 divides the frame into three divided frames, sorting out the divided frames on a port-by-port basis, and outputs the divided frames to the buffer 107.

The buffer 107 sorts out the divided frames on a port-by-port basis, temporarily stores the sorted-out divided frames, and outputs them to the interfaces 101-1 to 101-3. For example, the buffer 107 temporarily stores a divided frame that should be transmitted from the port A and outputs that divided frame to the interface 101-1. Similarly, the buffer 107 temporarily stores a divided frame that should be transmitted from the port B and outputs that divided frame to the interface 101-2. Similarly, the buffer 107 temporarily stores a divided frame that should be transmitted from the port C and outputs that divided frame to the interface 101-3.

Further, when there is no frame that should be output to the interfaces 101-1 to 101-3 in the buffer 107, it informs the controller 108 that the buffer 107 is empty. Further, the buffer 107 inserts a header output from the control header generator 109 into the divided frame and outputs the divided frame to the interfaces 101-1 to 101-3.

The control header generator 109 generates a control header according to an instruction from the controller 108 and outputs the generated control header to the buffer 107.

When the controller 108 receives network failure information, it degenerates the band. Further, when the controller 108 receives information that the network failure has been solved, it cancels the degeneracy of the band.

Specifically, when the interfaces 101-1 to 101-3 cannot perform communication with a counterpart communication apparatus, they inform the controller 108 that a failure has occurred in the link. Then, when the controller 108 is informed that a failure has occurred in the link from one of the interfaces 101-1 to 101-3, the controller 108 determines that a failure has occurred in the link in communication by using the corresponding port.

Further, when the coupler 103 has failed in coupling divided frames, it outputs information that the coupling has failed to the controller 108. For example, when some number is skipped in the order of the sequence number, the coupler 103 outputs information that the coupling of frames has failed and the skipped sequence number (or a corresponding port) to the controller 108. Then, the controller 108 determines that a failure has occurred in the link in communication using the port corresponding to the skipped sequence number.

By the above-described determination, the controller 108 identifies the port of the communication path in which the failure has occurred in the link and transmits divided frames to the entity with which the communication apparatus 100 communicates without using the port in which the failure has occurred. For example, when the port of the communication path in which the failure has occurred in the link is the port A, the controller 108 instructs the divider 106 to divide a frame into two frames for the ports B and C and transmit the divided frames from the ports B and C. Then, the divided frames are transmitted from the interface 101-2 corresponding to the port B and the interface 101-3 corresponding to the port C.

Meanwhile, a determination for cancelling degeneracy is performed by reception of divided frames in which control information is inserted on a port-by-port basis. That is, when control information is included in CH information of a received divided frame, it can be determined that communication has been successfully performed for the port through which that divided frame has been received. When the controller 108 has received a control signal through a port in which a failure has occurred in the link and which has been excluded based on the content of CH information from the CH information checker 102, the controller 108 determines that that port has been restored to a state in which communication can be performed and adds that port as a port through which a divided frame is transmitted.

For example, in a degenerated state in which a frame is divided into two frames for the ports B and C and transmitted therethrough and the port A is not used, when the controller 108 receives a control signal through the port A, it instructs the divider 106 to divide a frame into three frames for the ports A, B and C and transmitted them therethrough. The divided frames are transmitted from the interface 101-1 corresponding to the port A, the interface 101-2 corresponding to the port B, and the interface 101-3 corresponding to the port C.

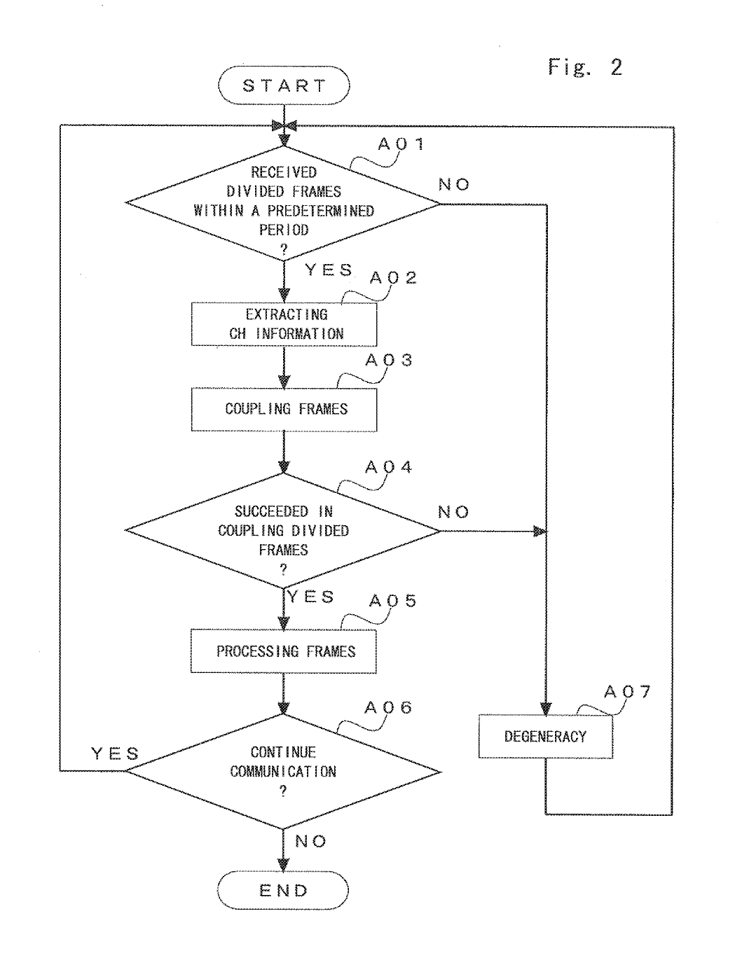

By the above-described configuration, the communication apparatus 100 carries out detection of a failure in the link or a failure in the network due to a frame loss between apparatuses, degeneracy of the band, and cancellation of the degeneracy. Next, an operation of the communication apparatus 100 is explained. FIG. 2 is a flowchart showing an operation of a communication apparatus according to this embodiment. The flowchart shown in FIG. 2 includes steps A01 to A07.

Firstly, in the step A01, the interfaces 101-1 to 101-3 determine whether or not they have been able to receive divided frames from the counterpart communication apparatus within a specific period. Then, when they have been able to receive divided frames in the specific period, the process proceeds to the step A02, whereas when they have not been able to receive divided frames in the specific period, the process proceeds to the step A07. In the step A02, the CH information checker 102 extracts CH information from the divided frame and outputs the extracted CH information to the controller 108. Then, the process proceeds to the step A03.

In the step A03, the coupler 103 couples the divided frames in the order of their sequence numbers and the process proceeds to the step A04.

In the step A04, the coupler 103 determines whether the coupling of the divided frames has succeeded or failed. When the coupling of the divided frames has succeeded, the process proceeds to the step A05, whereas when the coupling of the divided frames has failed, the process proceeds to the step A07.

In the step A05, the coupled frame is processed in the communication device 104 and the interface 105 and the process proceeds to the step A06.

In the step A06, when the communication apparatus 100 continues the communication, the process returns to the step A01, whereas when the communication apparatus 100 finishes the communication, the process is finished.

In the step A07, the controller 108 excludes the port corresponding to the link in which the failure has occurred in the step A01, A04 or A04 from the communication, and thereby degenerates the band. Then, the process returns to the step A01.

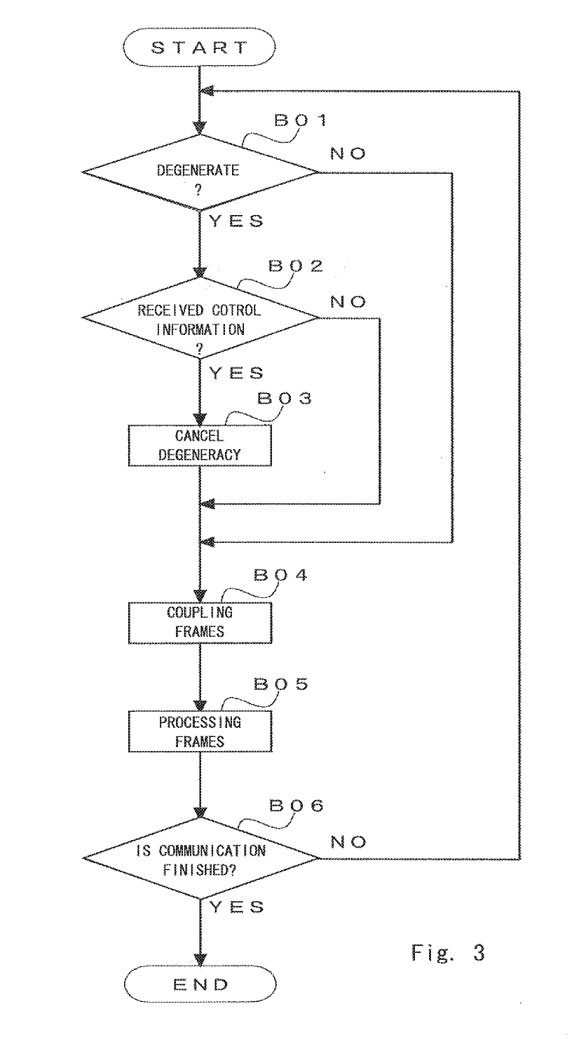

Through the above-described operation, the communication apparatus 100 degenerates the band for which the link aggregation has been implemented. Next, an operation for cancelling degeneracy is explained. FIG. 3 is a flowchart showing an operation of a communication apparatus according to this embodiment. The flowchart shown in FIG. 3 includes steps B01 to B06.

Firstly, in the step B01, the controller 108 determines whether or not the band for which the link aggregation is implemented has been degenerated. Then, when the band has been degenerated, the process proceeds to the step B02, whereas when the band has not been degenerated, the process proceeds to the step B04.

In the step B02, the CH information checker 102 determines whether or not a frame including control information has been received through a port that has been excluded from the link aggregation due to the degeneracy of the band. Then, when a frame including control information has been received, the process proceeds to the step B03, whereas when a frame including control information has not been received, the process proceeds to the step B04.

In the step B03, the controller 108 cancels the degeneracy and the process proceeds to the step B04. In the step B04, the communication apparatus 100 receives divided frames and performs a coupling process. Then, the process proceeds to the step B05.

In the step B05, the coupled frame is processed in the communication device 104 and the interface 105 and the process proceeds to the step B06.

In the step B06, when the communication apparatus 100 continues the communication, the process returns to the step B01, whereas when the communication apparatus 100 finishes the communication, the process is finished.

By the above-described configuration, the communication apparatus 100 detects a failure in the link or a failure in the network due to a frame loss between apparatuses, degenerates the band for which the link aggregation is implemented, and cancels the degeneracy.

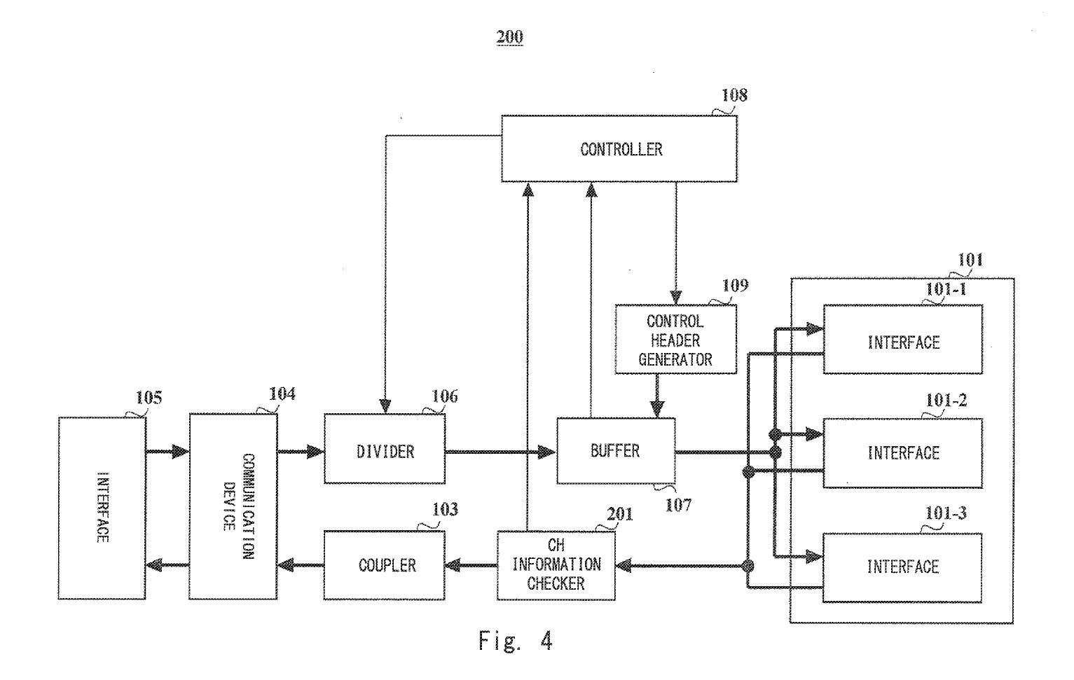

Next, a communication apparatus that communicates with the communication apparatus 100 is explained. FIG. 4 is a block diagram showing a configuration of a communication apparatus according to this embodiment. In FIG. 4, the same numbers as those in FIG. 1 are assigned to the same structures as those in FIG. 1, and their explanations are omitted. In FIG. 4, a communication apparatus 200 includes an interface 101, a CH information checker 201, a coupler 103, a communication device 104, an interface 105, a divider 106, a buffer 107, a controller 108, and a control header generator 109.

The interfaces 101-1 to 101-3 receive divided frames transmitted from a counterpart communication apparatus and output them to the CH information checker 201.

The CH information checker 201 checks a content of CH information of the received divided frame and detects the presence/absence of information indicating signal failure (SF). Then, the CH information checker 201 outputs information on a port corresponding to the received divided frame and the SF to the controller 108.

Similarly, the CH information checker 201 detects whether or not control information is included in the CH information of the received divided frame. Then, the CH information checker 201 outputs information on a port corresponding to the received divided frame and the control information to the controller 108. Specifically, the control information preferably includes information as to whether frames to be transmitted should be coupled or should not be coupled.

Further, the CH information checker 201 extracts a sequence number included in the CH information of the received divided frame and outputs the extracted sequence number together with the divided frame to the coupler 103. This sequence number indicates an order according to which the divided frames are coupled.

The coupler 103 couples the divided frames according to the order of the sequence number and outputs the coupled frame to the communication device 104.

When the controller 108 receives network failure information, it degenerates the band. Further, when the controller 108 receives information that the network failure has been solved, it cancels the degeneracy of the band.

Specifically, the CH information checker 201 associates an SF included in a header of the divided frame with a port through which that divided frame has been received, and informs the controller 108 of them in the associated state. The controller 108 determines that a failure has occurred in the link in the port through which a divided frame including an SF has not been received.

By the above-described determination, the controller 108 identifies the port of the communication path in which the failure has occurred in the link and transmits divided frames to the entity with which the communication apparatus 200 communicates without using the port in which the failure has occurred. For example, when the port of the communication path in which the failure has occurred in the link is the port A, the controller 108 instructs the divider 106 to divide a frame into two frames for the ports B and C and transmit the divided frames from the ports B and C. Then, the divided frames are transmitted from the interface 101-2 corresponding to the port B and the interface 101-3 corresponding to the port C.

Meanwhile, a determination for cancelling degeneracy is performed by reception of divided frames in which control information is inserted on a port-by-port basis. That is, when control information is included in CH information of a received divided frame, it can be determined that communication has been successfully performed for the port through which that divided frame has been received. When the controller 108 has received a control signal through a port in which a failure has occurred in the link and which has been excluded based on the content of CH information from the CH information checker 201, the controller 108 determines that that port has been restored to a state in which communication can be performed and adds that port as a port through which a divided frame is transmitted.

For example, in a degenerated state in which a frame is divided into two frames for the ports B and C and transmitted therethrough and the port A is not used, when the controller 108 receives a control signal through the port A, it instructs the divider 106 to divide a frame into three frames for the ports A, B and C and transmitted them therethrough. The divided frames are transmitted from the interface 101-1 corresponding to the port A, the interface 101-2 corresponding to the port B, and the interface 101-3 corresponding to the port C.

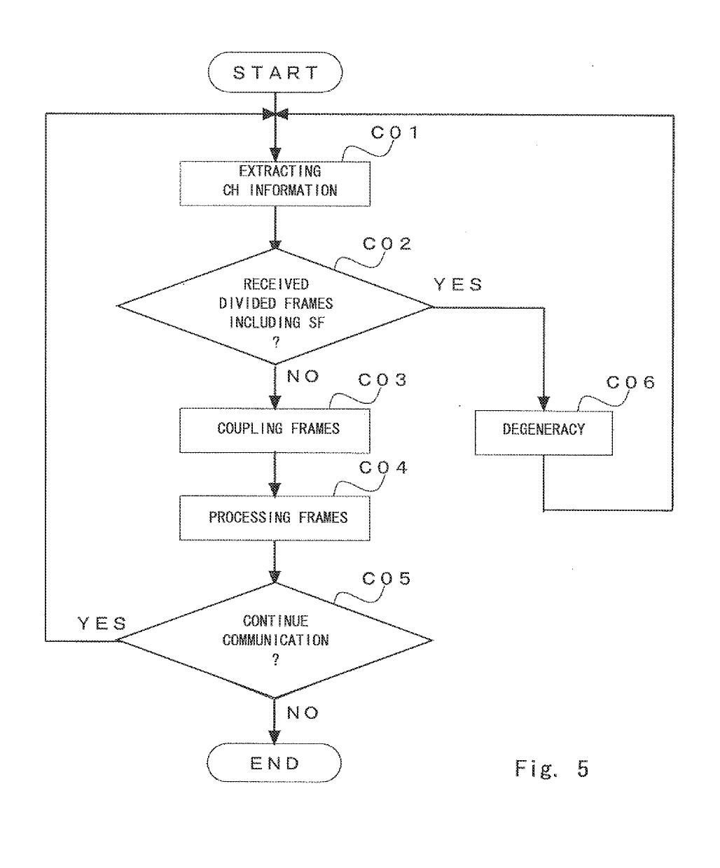

By the above-described configuration, the communication apparatus 200 carries out degeneracy of the band and cancellation of the degeneracy. Next, an operation of the communication apparatus 200 is explained. FIG. 5 is a flowchart showing an operation of a communication apparatus according to this embodiment. The flowchart shown in FIG. 5 includes steps C01 to C06.

Firstly, in the step C01, the CH information checker 201 extracts CH information from the divided frame and outputs the extracted CH information to the controller 108. Then, the process proceeds to the step C02.

In the step C02, the controller 108 determines whether or not there is a port through which a divided frame including an SF has not been received. Then, when there is a port through which a divided frame including an SF has not been received, the process proceeds to the step C06, whereas when there is no port through which a divided frame including an SF has not been received, the process proceeds to the step C03. Note that the step C02 is an operation that corresponds to a case where a divided frame including an SF is transmitted from the communication entity with which the communication apparatus 200 communicates as a result of a link failure.

In the step C03, the coupler 103 couples the divided frames in the order of their sequence numbers and the process proceeds to the step C04.

In the step C04, the coupled frame is processed in the communication device 104 and the interface 105 and the process proceeds to the step C05.

In the step C05, when the communication apparatus 200 continues the communication, the process returns to the step C01, whereas when the communication apparatus 200 finishes the communication, the process is finished.

In the step C06, the controller 108 excludes the port corresponding to the link in which the failure has occurred in the step C01, C02 or C05 from the communication, and thereby degenerates the band. Then, the process returns to the step C01.

Through the above-described operation, the communication apparatus 200 degenerates the band for which the link aggregation has been implemented. Note that the operation for cancelling the degeneracy is similar to the operation performed by the communication apparatus 100 shown in FIG. 3.

Next, a communication system using communication apparatuses 100 and 200, and degeneracy of a communication band and cancellation of the degeneracy are explained.

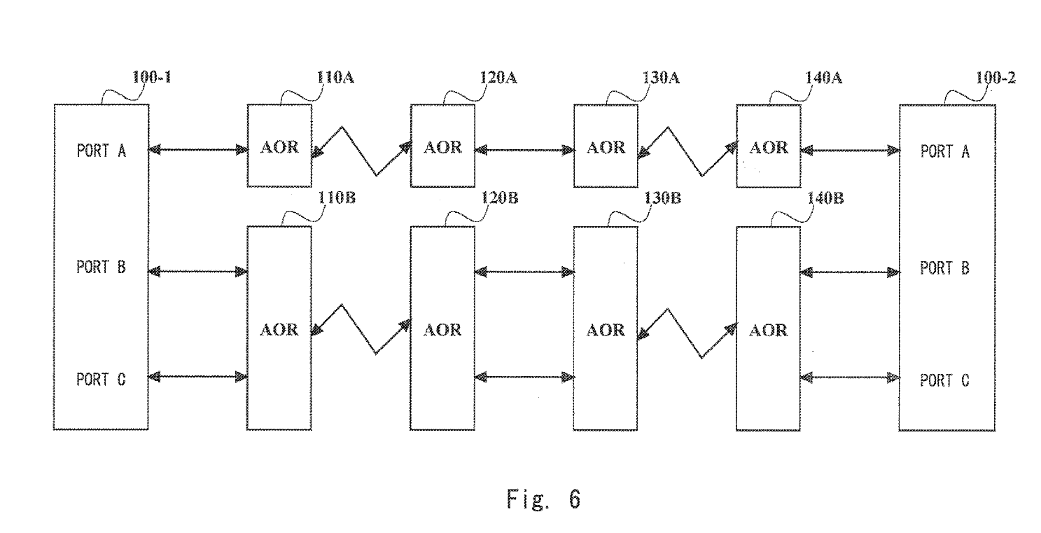

FIG. 6 shows an outline of a communication system using communication apparatuses according to this embodiment. In FIG. 6, a communication apparatus 100 includes the configuration of the communication apparatus 100 shown in FIG. 1 and a communication apparatus 200 includes the configuration of the communication apparatus 200 shown in FIG. 4. Further, the communication apparatuses 100 and 200 form a link through AORs 110A to 140B and perform communication. Each of the AORs 110A to 140B is an outdoor integral-type communication system (i.e., an AOR: All Outdoor Radio) and relays communication through a wire or wirelessly.

Each of the communication apparatuses 100 and 200, and the AORs 110A to 140B communicates with an apparatus that is adjacent to and opposed to that apparatus as shown in FIG. 6.

Further, communication through the port A is performed through a path of the communication apparatus 100, the AORs 110A, 120A, 130A and 140A, and the communication apparatus 200. Similarly, communication through the ports B and C is performed through a path of the communication apparatus 100, the AORs 110B, 120B, 130B and 140B, and the communication apparatus 200.

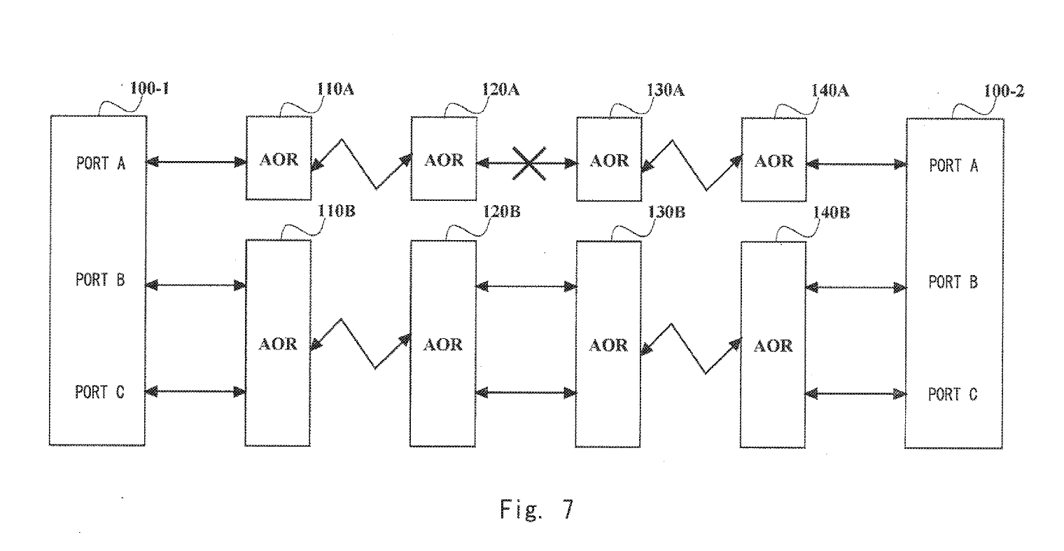

Here, when a communication failure has occurred in a part of the link, the state of the communication system becomes a state shown in FIG. 7. FIG. 7 shows an outline of a communication system using communication apparatuses according to this embodiment. In FIG. 7, the same numbers as those in FIG. 6 are assigned to the same structures as those in FIG. 6, and their explanations are omitted.

As shown in FIG. 7, when a failure occurs in a link between the AORs 120A and 130A, the AORs 120A and 130A can detect the occurrence of the failure. However, since the communication between the AORs 120A and 130A is for the opposed communication apparatuses, the communication apparatuses 100 and 200 (and the AORs 110A and 140A) requires a configuration for detecting the failure between the AORs 120A and 130A.

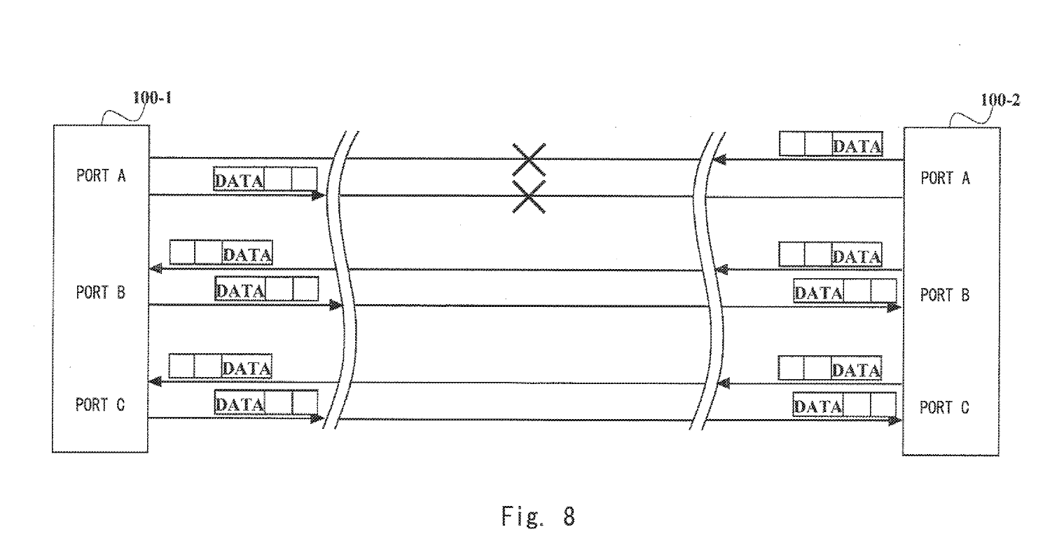

In this embodiment, by the configuration of the communication apparatus 100 shown in FIG. 1, the communication apparatuses 100 and 200 detect a failure in the link between the AORs 120A and 130A, which are not adjacent to the communication apparatuses 100 and 200, or a failure in the network due to a frame loss between the apparatuses, and degenerates the band. Transmission and reception of signals between the communication apparatuses 100 and 200 are explained hereinafter. FIGS. 8 to 12 are schematic diagrams showing examples of transmission and reception of signals in the communication system according to this embodiment. FIGS. 8 to 12 correspond to FIGS. 6 and 7, and the AORs 110A to 140B are omitted in the figures.

When a failure occurs in the path of the port A as shown in FIG. 8, a divided frame that passes through the port A cannot reach the communication apparatus 100 or 200. That is, only divided frames that pass through the ports B or C reach the communication apparatus 100 or 200.

Since the communication apparatus 100 cannot receive the divided frame through the port A, it fails in coupling the divided frames of the ports A to C.

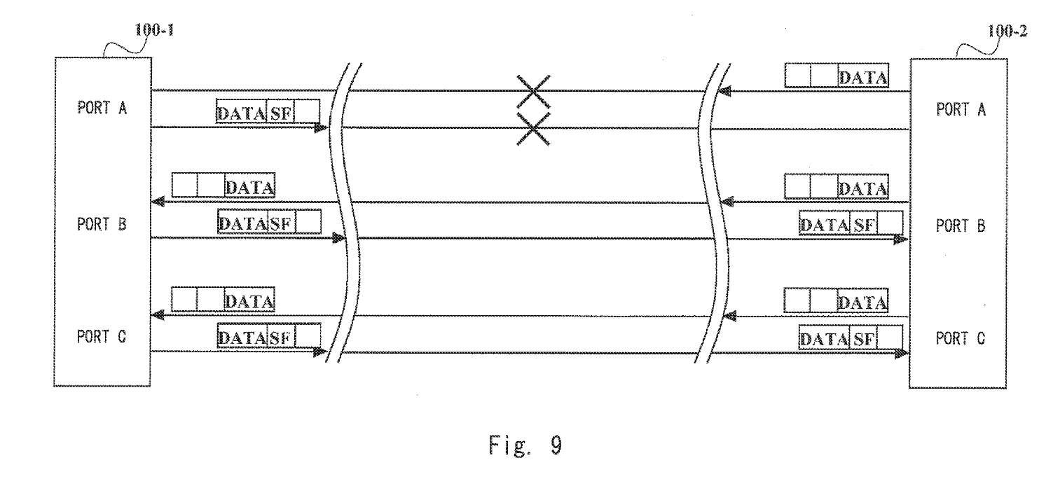

Therefore, as shown in FIG. 9, the communication apparatus 100 transmits a signal with an SF assigned thereto to the communication apparatus 200 through the ports A to C. After that, the communication apparatus 100 degenerates the ports A to C into the ports B and C. Although the communication apparatus 200 can receive the signal with the SF assigned thereto through the ports B and C, it cannot receive the signal with the SF assigned thereto through the port A due to the failure. Therefore, the communication apparatus 200 degenerates the band into the ports B and C through which the signal with the SF assigned thereto has been able to be received.

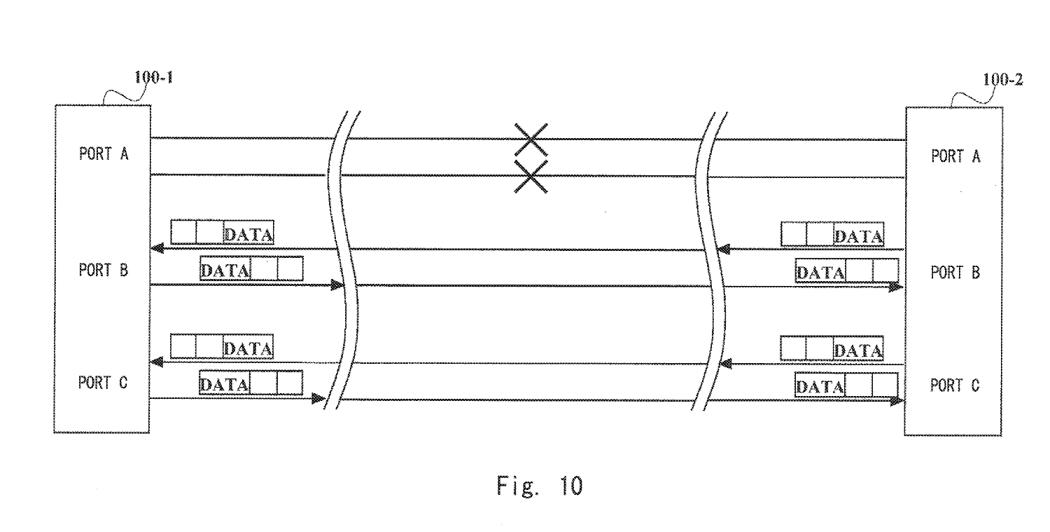

Since both of the communication apparatuses 100 and 200 degenerate the band into the ports B and C, they perform communication through the ports B and C as shown in FIG. 10.

As described above, when the communication system according to this embodiment detect an occurrence of a failure, it transmits a signal including an SF from each of the ports and the communication entity on the other side degenerates the band into the ports through which the signal including the SF has been able to be received.

Next, cancellation of degeneracy is explained. For example, when a specific period has elapsed from the degenerated state shown in FIG. 10, an operation for checking whether or not the degeneracy can be cancelled is performed.

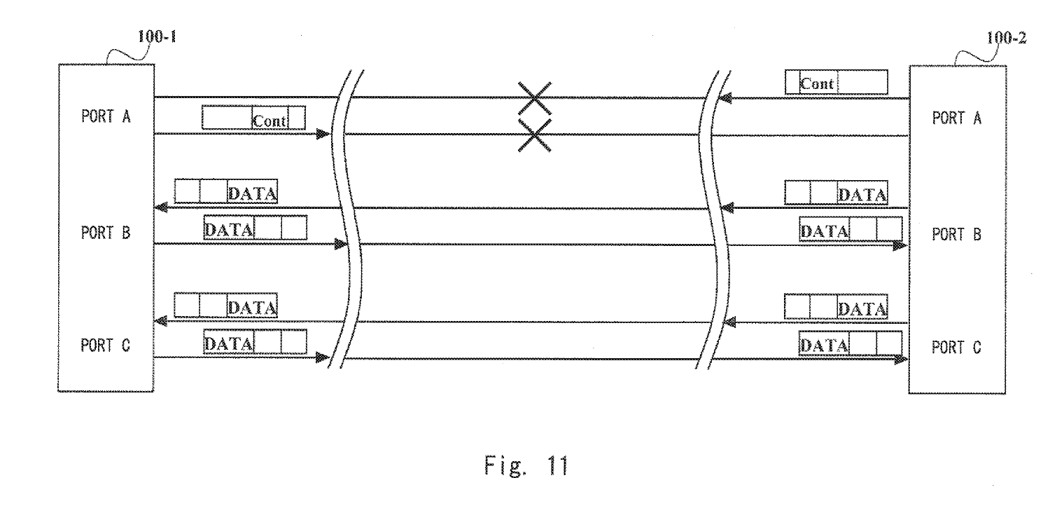

As shown in FIG. 11, the communication apparatuses 100 and 200 transmit a signal including a control signal through the port A, which has been stopped performing communication due to the degeneracy. Since FIG. 11 shows a state in which the path of the port A has not been restored from the failure, the signal including the control signal does not reach the communication entity on the other side.

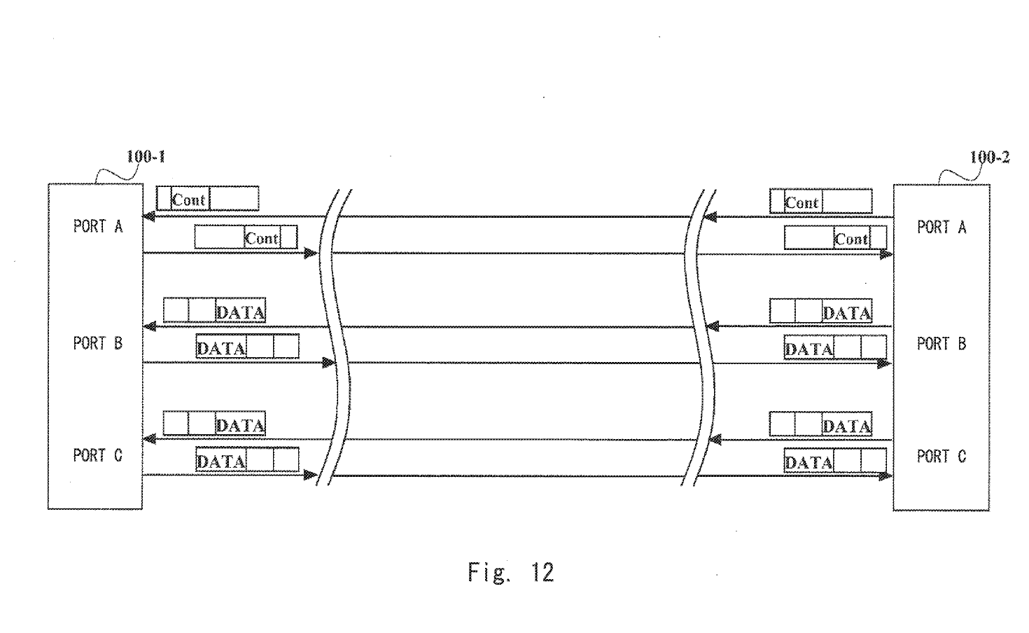

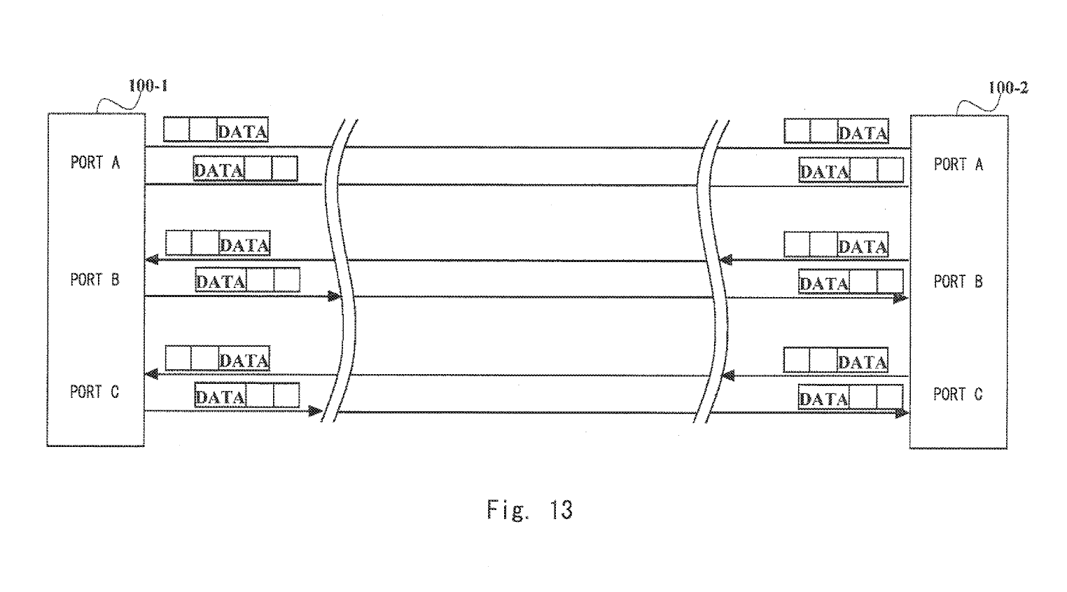

As shown in FIG. 12, when the path of the port A has been restored from the failure, each of the communication apparatuses 100 and 200 can receive a signal including a control signal from the communication entity on the other side. As a result, since the communication apparatuses 100 and 200 can determine that the path of the port A has been restored from the failure, the communication apparatuses 100 and 200 cancel the degeneracy and perform communication through the ports A to C as shown in FIG. 13.

As described above, when the communication system according to this embodiment has failed in coupling frames, it transmits a signal including an SF from each of the ports. By doing so, the communication system can detect a failure in the link or a failure in the network due to a frame loss between apparatuses in communication in which a flame is divided and divided frames are transmitted.

Further, the communication system according to this embodiment can degenerate the band in communication in which a frame is divided and divided frames are transmitted by degenerating the band into ports through which a signal including an SF has been able to be received.

Note that the present disclosure is not limited to the above-described embodiments and can be modified as appropriate without departing from the spirit and scope of the present disclosure.

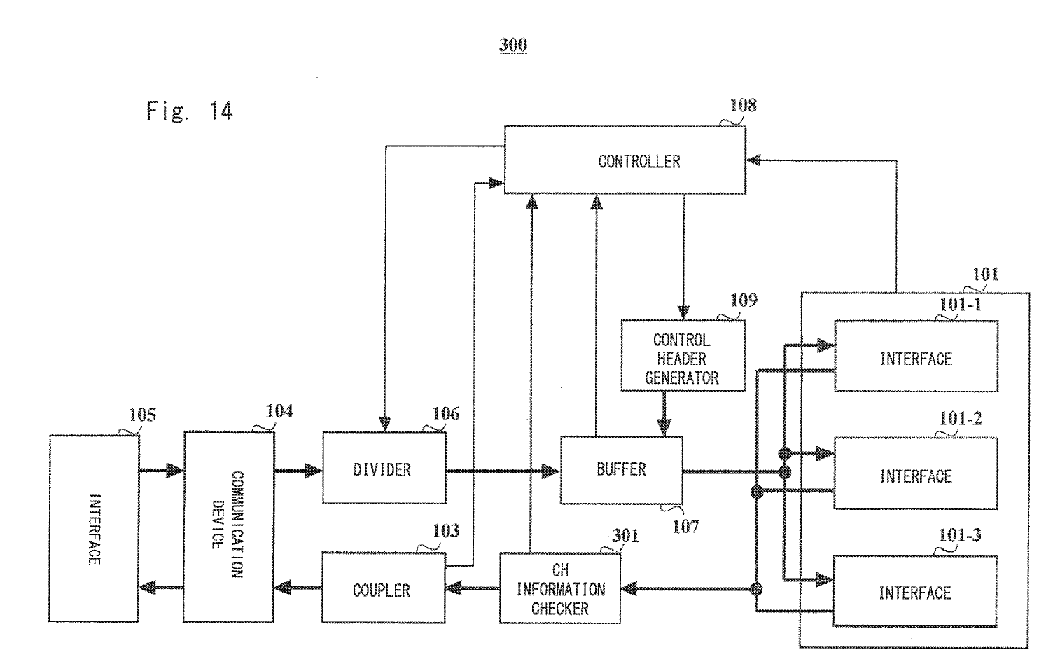

For example, an embodiment may include both the communication apparatus 100 shown in FIG. 1 and the communication apparatus 200 shown in FIG. 4. FIG. 14 is a block diagram showing a configuration of a communication apparatus according to this embodiment. In FIG. 14, the same numbers as those in FIG. 1 are assigned to the same structures as those in FIG. 1, and their explanations are omitted. In FIG. 14, a communication apparatus 300 includes an interface 101, a CH information checker 301, a coupler 103, a communication device 104, an interface 105, a divider 106, a buffer 107, a controller 108, and a control header generator 109.

Further, the interface 101 includes interfaces 101-1 to 101-3 which perform communication on a port-by-port basis.

The CH information checker 301 checks a content of CH information of the received divided frame and detects the presence/absence of information indicating signal failure (SF). Then, the CH information checker 301 outputs information on a port corresponding to the received divided frame and the SF to the controller 108.

Similarly, the CH information checker 301 detects whether or not control information is included in the CH information of the received divided frame. Then, the CH information checker 301 outputs information on a port corresponding to the received divided frame and the control information to the controller 108. Specifically, the control information preferably includes information as to whether frames to be transmitted should be coupled or should not be coupled.

Further, the CH information checker 301 extracts a sequence number included in the CH information of the received divided frame and outputs the extracted sequence number together with the divided frame to the coupler 103. This sequence number indicates an order according to which the divided frames are coupled.

The coupler 103 couples the divided frames according to the order of the sequence number and outputs the coupled frame to the communication device 104. Further, when the coupler 103 has failed in coupling divided frames, it outputs information that the coupling has failed to the controller 108. For example, when some number is skipped in the order of the sequence number, the coupler 103 outputs information that the coupling of frames has failed and the skipped sequence number (or information on a corresponding port) to the controller 108.

When the controller 108 receives network failure information, it degenerates the band. Further, when the controller 108 receives information that the network failure has been solved, it cancels the degeneracy of the band.

Specifically, when the interfaces 101-1 to 101-3 cannot perform communication with a counterpart communication apparatus, they inform the controller 108 that a failure has occurred in the link. Then, when the controller 108 is informed that a failure has occurred in the link from one of the interfaces 101-1 to 101-3, the controller 108 determines that a failure has occurred in the link in communication by using the corresponding port.

Further, when the coupler 103 has failed in coupling divided frames, it outputs information that the coupling has failed to the controller 108. For example, when some number is skipped in the order of the sequence number, the coupler 103 outputs information that the coupling of frames has failed and the skipped sequence number (or a corresponding port) to the controller 108. Then, the controller 108 determines that a failure has occurred in the link in communication using the port corresponding to the skipped sequence number.

Furthermore, the CH information checker 301 associates an SF included in a header of the divided frame with a port through which that divided frame has been received, and informs the controller 108 of them in the associated state. The controller 108 determines that a failure has occurred in the link in the port through which a divided frame including an SF has not been received.

By the above-described determination, the controller 108 identifies the port of the communication path in which the failure has occurred in the link and transmits divided frames to the entity with which the communication apparatus 300 communicates without using the port in which the failure has occurred.

Meanwhile, a determination for cancelling degeneracy is performed by reception of divided frames in which control information is inserted on a port-by-port basis. That is, when control information is included in CH information of a received divided frame, it can be determined that communication has been successfully performed for the port through which that divided frame has been received. When the controller 108 has received a control signal through a port in which a failure has occurred in the link and which has been excluded based on the content of CH information from the CH information checker 301, the controller 108 determines that that port has been restored to a state in which communication can be performed and adds that port as a port through which a divided frame is transmitted.

By the above-described configuration, the communication apparatus 300 carries out detection of a failure in the link or a failure in the network due to a frame loss between apparatuses, degeneracy of the band, and cancellation of the degeneracy.

Further, the above-described configuration is preferably formed by a logic circuit such as an ASIC (Application Specific Integrated Circuit). However, the configuration may be implemented by a circuit such as a CPU (Central Processing Unit).

Although the present disclosure is explained above with reference to embodiments, the present disclosure is not limited to the above-described embodiments. Various modifications that can be understood by those skilled in the art can be made to the configuration and details of the present disclosure within the scope of the present disclosure.

This application is based upon and claims the benefit of priority from Japanese patent applications No. 2015-4661, filed on Jan. 14, 2015, the disclosure of which is incorporated herein in its entirety by reference.

### Industrial Applicability

The present disclosure can be used for a communication apparatus or a communication system.

### Reference Signs List

100, 200, 300 COMMUNICATION APPARATUS

101 INTERFACE

101-1 TO 101-3, 104 INTERFACE

102, 201, 301 CH INFORMATION CHECKER

103 COUPLER

105 INTERFACE

106 DIVIDER

107 BUFFER

108 CONTROLLER

109 CONTROL HEADER GENERATOR

1. A communication apparatus comprising:
a transmitter-receiver configured to receive divided frames transmitted through a plurality of paths, the divided frames being obtained by dividing a frame; and
a coupler configured to couple the divided frames, wherein
when the coupling of the divided frames has failed in the coupler, the transmitter-receiver transmits a signal-faulty signal indicating a transmission fault.

2. A communication apparatus comprising:
a plurality of transmitters-receivers; and
a divider configured to divide a frame into divided frames, wherein
when the transmitters-receivers receive a signal-faulty signal, the transmitters-receivers transmit the divided frames through a path through which the signal-faulty signal is able to be received.

3. A communication apparatus comprising:
a divider configured to divide a frame into divided frames;
a transmitter-receiver configured to transmit the divided frames and receive divided frames transmitted through a plurality of paths, the divided frames being obtained by dividing a frame; and
a coupler configured to couple the received divided frames, wherein
when the coupling of the received divided frames has failed in the coupler, the transmitter-receiver transmits a signal-faulty signal indicating a transmission fault.

4. The communication apparatus according to claim 1, wherein
the coupler detects whether or not divided frames to be coupled have been received, and
the transmitter-receiver transmits/receives divided frames through a path through which the divided frames to be coupled have been received.

5. The communication apparatus according to claim 1, wherein the transmitter-receiver detects whether or not there is a failure in a link in a physical layer on a path-by-path basis, and transmits/receives divided frames through a path in which there is no failure.

6. The communication apparatus according to claim 2, further comprising a header checker configured to detect whether or not there is a signal-faulty signal in header information of a received divided frame on a path-by-path basis, wherein
when the transmitter-receiver receives a signal-faulty signal, the transmitter-receiver transmits/receives divided frames through a path through which the signal-faulty signal is able to be received.

7. The communication apparatus according to claim 1, wherein when a specific period has elapsed after a signal-faulty signal is transmitted or received, the transmitter-receiver transmits a control signal by using at least an excluded path.

8. The communication apparatus according to claim 2, further comprising:
a buffer configured to temporarily store a frame to be transmitted and detect presence/absence of the frame to be transmitted; and
a control header generator configured to generate a control signal, wherein
when there is no frame to be transmitted in the buffer, the control header generator generates a control signal,
the buffer forms a divided frame including the control signal, and
the transmitter-receiver transmits the divided frame including the control signal.

9. The communication apparatus according to claim 1, wherein the transmitter-receiver uses a path through which the control signal is received as a communication path for the divided frame.

10. The communication apparatus according to claim 1, wherein the transmitter-receiver transmits/receives a divided frame in a low-level layer, the divided frame being obtained by dividing a frame in a high-level layer.

11. A communication system configured to perform communication through a plurality of paths, the communication system comprising:
a first communication apparatus configured to divide a frame and transmit divided frames through the plurality of paths; and
a second communication apparatus configured to receive the divided frames through the plurality of paths and couple the received frames, wherein
when the coupling of the frames has failed, the second communication apparatus transmits a signal-faulty signal indicating a transmission fault to the first communication apparatus.

12. The communication system according to claim 11, wherein the first communication apparatus degenerates a band by excluding a path through which a signal-faulty signal indicating a transmission fault is not able to be received.

13. A communication method in which first and second communication apparatuses perform communication through a plurality of paths, the communication method comprising:
a divided frame transmission step of, in the first communication apparatus, dividing a frame and transmitting divided frames through respective paths;
a coupling step of, in the second communication apparatus, coupling frames received through the plurality of paths; and
an SF signal transmission step of, in the second communication apparatus, transmitting a signal-faulty signal indicating a transmission fault to the first communication apparatus when the coupling of the frames has failed.

14. The communication method according to claim 13, further comprising a degenerating step of degenerating a band in the first communication apparatus by excluding a path through which a signal-faulty signal indicating a transmission fault is not able to be received.
